(19) United States
(12) Patent Application Publication
(10) Pub. No.: US 2026/0342264 A1
(43) Pub. Date: Oct. 29, 2026

(54) Inverter Control Device and Electric Vehicle

(71) Applicant: Hitachi Astemo, Ltd., Hitachinaka-shi, Ibaraki (JP)

(72) Inventors: Toshiyuki AJIMA, Tokyo (JP); Masahiro HORI, Tokyo (JP); Takafumi HARA, Tokyo (JP); Shun TANIGUCHI, Tokyo (JP); Tetsuo MATSUMURA, Hitachinaka-shi (JP)

(21) Appl. No.: 19/110,888

(22) PCT Filed: Oct. 4, 2023
(86) PCT No.: PCT/JP2023/036291

§ 371 Date: Mar. 12, 2025

(30) Foreign Application Priority Data
Oct. 7, 2022 (JP) 2022-162797

(51) Int. Cl. H02P 27/08; B60L 15/00

(52) U.S. Cl. CPC H02P 27/08; B60L 15/007

(57) ABSTRACT

An inverter control device is a device for controlling an inverter that converts a direct current into a three-phase alternating current by driving a three-phase inverter circuit and outputs the three-phase alternating current to a motor. The device includes a PWM pulse generator that performs pulse width modulation on a three-phase voltage command using a carrier wave that cyclically changes, and generates a PWM pulse signal for controlling driving of the three-phase inverter circuit, and a target harmonic current calculation unit that calculates, based on a drive condition of the motor, a target harmonic current for reducing a stator loss and a rotor loss that respectively occur in a stator and a rotor of the motor due to a harmonic current flowing in the motor in response to the PWM pulse signal. The PWM pulse generator generates the PWM pulse signal that makes a zero-phase voltage to be non-zero based on the target harmonic current, the zero-phase voltage being the sum of three-phase output voltages from the three-phase inverter circuit.

### TECHNICAL FIELD

The present invention relates to an inverter control device and an electric vehicle including the inverter control device.

### BACKGROUND ART

An inverter control device that controls driving of an inverter by pulse width modulation (PWM) control to rotationally drive a motor has been widely used. In the driving of an inverter by such an inverter control device, it is known that there is, in addition to a switching loss due to a switching operation of the inverter and a fundamental wave loss due to a fundamental wave current flowing in a motor, a radio frequency loss in the motor due to a harmonic current that flows in the motor by PWM control.

For example, the technique of PTL 1 is known as a technique of reducing a radio frequency loss in a motor by controlling a PWM pulse to adjust the phase of a harmonic current. PTL 1 describes a motor control device that adjusts a phase difference between a three-phase voltage command and a triangular wave signal Tr that is a carrier wave so as to reduce an eddy current loss We in a magnet of a rotor of the motor according to a d-axis current Id applied to the motor and a motor rotational speed ωr representing a rotational speed of the motor.

### CITATION LIST

### Patent Literature

PTL 1: JP 2022-18168 A

### SUMMARY OF INVENTION

### Technical Problem

In the technique of PTL 1, it is necessary to control the phase of a carrier wave used for PWM control to be constant with respect to a fundamental wave of an output current of an inverter according to a three-phase voltage command. However, in the synchronous PWM control as in PTL 1, the phase accuracy of the carrier wave with respect to the fundamental wave may be reduced due to a detection error of the rotational position of the motor and an angle error due to a detection delay of the rotational position of the motor. In particular, in the synchronous PWM control in a multi-pulse region in which the number of PWM pulses per electrical angle cycle is larger than 15, the width of the electrical angle per pulse becomes relatively small, so that it is difficult to control the phase of the carrier wave with respect to the fundamental wave with high accuracy. As a result, the effect of reducing the harmonic loss of the motor is lost, and superiority over an asynchronous PWM control may be lost.

To solve the above problem, a main object of the present invention is to provide a technique capable of effectively reducing a radio frequency loss of a motor regardless of the number of PWM pulses per electrical angle cycle.

### Solution to Problem

An inverter control device of the present invention is a device for controlling an inverter that converts a direct current into a three-phase alternating current by driving a three-phase inverter circuit and outputs the three-phase alternating current to a motor, the device including a PWM pulse generator that performs pulse width modulation on a three-phase voltage command using a carrier wave that cyclically changes, and generates a PWM pulse signal for controlling driving of the three-phase inverter circuit, and a target harmonic current calculation unit that calculates, based on a drive condition of the motor, a target harmonic current for reducing a stator loss and a rotor loss that respectively occur in a stator and a rotor of the motor due to a harmonic current flowing in the motor in response to the PWM pulse signal, where the PWM pulse generator generates the PWM pulse signal that makes a zero-phase voltage to be non-zero based on the target harmonic current, the zero-phase voltage being the sum of three-phase output voltages from the three-phase inverter circuit.

An electric vehicle of the present invention includes a motor including a stator and a rotor, a battery that supplies a direct current, an inverter that includes a three-phase inverter circuit, coverts the direct current into a three-phase alternating current by driving the three-phase inverter circuit, and outputs the three-phase alternating current to the motor, and an inverter control device that controls the inverter, where the inverter control device includes a PWM pulse generator that performs pulse width modulation on a three-phase voltage command using a carrier wave that cyclically changes, and generates a PWM pulse signal for controlling driving of the three-phase inverter circuit, and a target harmonic current calculation unit that calculates, based on a drive condition of the motor, a target harmonic current for reducing a stator loss and a rotor loss that respectively occur in the stator and the rotor due to a harmonic current flowing in the motor in response to the PWM pulse signal, and the PWM pulse generator generates the PWM pulse signal that makes a zero-phase voltage to be non-zero based on the target harmonic current, the zero-phase voltage being the sum of three-phase output voltages from the three-phase inverter circuit.

### Advantageous Effects of Invention

According to the present invention, a radio frequency loss of a motor can be effectively reduced regardless of the number of PWM pulses per electrical angle cycle.

### BRIEF DESCRIPTION OF DRAWINGS

FIG. 1 is a block diagram illustrating a configuration of a motor drive system including an inverter control device according to a first embodiment of the present invention.

FIG. 2 is a diagram illustrating an example of a method of generating a PWM pulse signal in the inverter control device according to the first embodiment of the present invention.

FIG. 3 is a diagram illustrating an example of a harmonic loss that occurs in a motor.

FIG. 4 is a diagram illustrating a method of calculating a PWM pulse signal.

FIG. 5 is a flowchart illustrating a flow of calculation processing of a target harmonic current and a zero-phase voltage command in the inverter control device according to the first embodiment of the present invention.

FIG. 6 is a block diagram illustrating a configuration of a motor drive system including an inverter control device according to a second embodiment of the present invention.

FIG. 7 is a diagram illustrating an example of a method of generating a PWM pulse signal in the inverter control device according to the second embodiment of the present invention.

FIG. 8 is a flowchart illustrating a flow of calculation processing of a target harmonic current and a target phase value in the inverter control device according to the second embodiment of the present invention.

FIG. 9 is a view illustrating a configuration of an electric vehicle according to a third embodiment of the present invention.

### DESCRIPTION OF EMBODIMENTS

The present invention provides an inverter control device that controls an inverter by PWM control, and outputs a PWM pulse signal that has a zero-phase voltage, which is the sum of three-phase AC voltages output from the inverter, of non-zero, thereby increasing an output of the inverter while reducing a harmonic loss of a motor to reduce temperature degradation caused by heat generated by the motor. Hereinafter, embodiments of the present invention will be described with reference to the drawings.

### First Embodiment

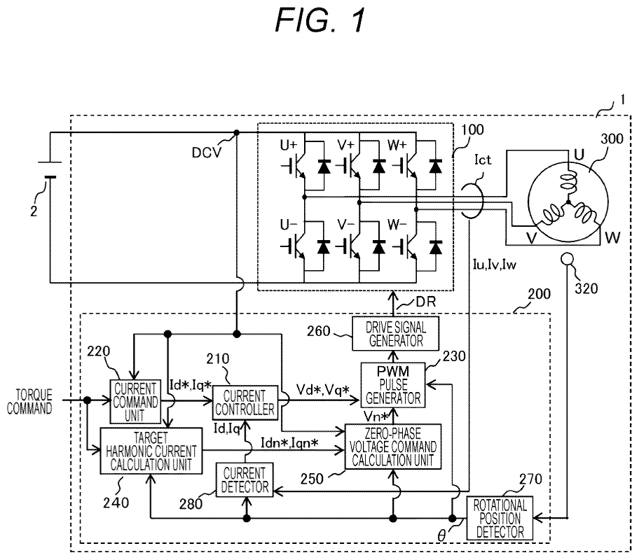

FIG. 1 is a block diagram illustrating a configuration of a motor drive system 1 including an inverter control device 200 according to a first embodiment of the present invention. The motor drive system 1 is connected to a battery 2 and includes an inverter 100, the inverter control device 200, and a motor 300.

The battery 2 is a DC voltage source of the inverter 100. The inverter 100 includes a three-phase inverter circuit including a plurality of semiconductor switching elements corresponding to phases of a three-phase AC voltage applied to the motor 300, and each semiconductor switching element of the three-phase inverter circuit is controlled to be turned on or off by the inverter control device 200. A DC voltage DCV of the battery 2 is thereby converted into a variable three-phase AC voltage of which frequency is variable and is output from the inverter 100 to be applied to the motor 300.

The motor 300 is a synchronous motor rotationally driven by a supplied three-phase AC voltage. A rotational position sensor 320 is attached to the motor 300 to control the phase of the three-phase AC voltage applied from the inverter 100 to the motor 300 according to the phase of an induced voltage of the motor 300. For example, a resolver including an iron core and a winding wire can be used as the rotational position sensor 320. Alternatively, the rotational position sensor 320 may be configured using a Giant Magneto Resistive effect (GMR) sensor or a Hall element.

The inverter control device 200 includes functional blocks that are a current controller 210, a current command unit 220, a PWM pulse generator 230, a target harmonic current calculation unit 240, a zero-phase voltage command calculation unit 250, a drive signal generator 260, a rotational position detector 270, and a current detector 280. The inverter control device 200 includes, for example, a microcomputer, and can implement these functional blocks by executing a predetermined program in the microcomputer. Alternatively, some or all of these functional blocks may be implemented using a hardware circuit such as a logic integrated (IC) or a field programmable gate array (FPGA).

The rotational position detector 270 detects the rotational position (electrical angle) θ of the rotor in the motor 300 based on the output signal of the rotational position sensor 320.

The current detector 280 acquires detected current values of three phases (Iu, Iv, and Iw) flowing in the motor 300 from a current sensor Ict, and performs three-phase/two-phase conversion on these detected current values based on the rotational position θ detected by the rotational position detector 270 to obtain detected current values (Id and Iq) along dq axes.

The inverter control device 200 has a current control function for controlling the output of the motor 300. The current command unit 220 calculates current command values (Id*, Iq*) based on a torque command input from a master controller (not illustrated) and the DC voltage DCV of the battery 2, and outputs the current command values to the current controller 210. The current controller 210 outputs voltage commands (Vd*, Vq*) so as the detected current values (Id, Iq) detected by the current detector 280 to match the current command values (Id*, Iq*) input from the current command unit 220.

The target harmonic current calculation unit 240 calculates target harmonic currents (Idn*, Iqn*) for reducing a stator loss and a rotor loss respectively occurring in the stator and the rotor of the motor 300 based on the torque command input from the master controller (not illustrated), the DC voltage DCV of the battery 2, and a motor speed which is a temporal change of the rotational position θ detected by the rotational position detector 270. In the stator and the rotor of the motor 300, a harmonic current flowing in the motor 300 in response to the PWM pulse signal output from the PWM pulse generator 230 to the drive signal generator 260 causes radio frequency losses (stator loss and rotor loss). The target harmonic current calculation unit 240 specifies a drive condition of the motor 300 from the torque command and the motor speed, and based on the specified drive condition of the motor 300 calculates a d-axis target harmonic current Idn* and a q-axis target harmonic current Ign* for reducing the harmonic loss. Details of a method of calculating the target harmonic currents (Idn*, Iqn*) by the target harmonic current calculation unit 240 will be described later.

The zero-phase voltage command calculation unit 250 calculates a zero-phase voltage command Vn* for adjusting a phase α of the PWM pulse signal generated by the PWM pulse generator 230 to a predetermined target phase value based on the target harmonic currents (Idn*, Iqn*) calculated by the target harmonic current calculation unit 240 and the DC voltage DCV of the battery 2. The zero-phase voltage command Vn* is a voltage command for changing the zero-phase voltage Vn, which is the sum of three-phase output voltages Vu, Vv, and Vw output from the inverter 100 to the motor 300 in response to the PWM pulse signal, to a non-zero value. Details of a method of calculating the zero-phase voltage command Vn* by the zero-phase voltage command calculation unit 250 will be described later.

The PWM pulse generator 230 performs three-phase pulse width modulation (PWM) based on the voltage commands (Vd*, Vq*) obtained by the current controller 210, the zero-phase voltage command Vn* obtained by the zero-phase voltage command calculation unit 250, and the rotational position θ to generate a PWM pulse signal for controlling the inverter 100. Specifically, for example, the PWM pulse generator 230 calculates the three-phase voltage commands Vu*, Vv*, and Vw* (U-phase voltage command value Vu*, V-phase voltage command value Vv*, and W-phase voltage command value Vw*) by performing two-phase/three-phase conversion on the voltage commands (Vd*, Vq*) using the rotational position θ. Then, the zero-phase voltage command Vn* is subtracted from each of the obtained three-phase voltage commands Vu*, Vv*, and Vw* to obtain three-phase voltage commands Vcu*, Vcv*, and Vcw* from the zero-phase voltage adjustment, and these voltage command values are compared with a carrier wave that cyclically changes at a carrier frequency fc. Accordingly, the position (phase) of a pulse edge in each phase can be determined to generate a PWM pulse signal for each phase. The carrier frequency fc may be constant, or may change according to the rotational speed (number of rotation) of the motor 3.

As described above, the zero-phase voltage command Vn* output from the zero-phase voltage command calculation unit 250 is a voltage command for making the zero-phase voltage Vn, which is the sum of the phase voltages output from the inverter 100 to the motor 300 in response to the PWM pulse signal, non-zero. This is calculated by the zero-phase voltage command calculation unit 250 based on the target harmonic currents (Idn*, Ign*) calculated by the target harmonic current calculation unit 240. Therefore, the PWM pulse generator 230 can generate, based on the target harmonic currents (Idn*, Iqn*), a PWM pulse signal that makes the zero-phase voltage Vn, which is the sum of the phase voltages output from the three-phase inverter circuit of the inverter 100, non-zero.

The drive signal generator 260 converts the PWM pulse signal generated by the PWM pulse generator 230 into a drive signal DR and outputs the drive signal DR to the inverter 100. In the inverter 100, each semiconductor switching element of the three-phase inverter circuit is controlled to be turned on or off in response to the drive signal DR. Accordingly, the three-phase inverter circuit is driven by the control by the inverter control device 200 to adjust the output voltage from the inverter 100 to the motor 300, whereby a three-phase alternating current flowing in the motor 300 is adjusted to control the torque of the motor 300.

In the example of the configuration of the motor drive system 1 described with reference to FIG. 1, the torque of the motor 300 is controlled in response to the torque command from the master controller, but the configuration of FIG. 1 can be applied also for a case that adopts a different control method. For example, in a case of controlling the rotational speed of the motor 300, the motor rotational speed ωr is calculated by the temporal change of the rotational position θ, and a voltage command or a current command is generated so as the motor rotational speed ωr to match a speed command from the master controller. When controlling the current of the motor 300, current commands (Id*, Iq*) from the master controller are input to the current controller 210 and the target harmonic current calculation unit 240.

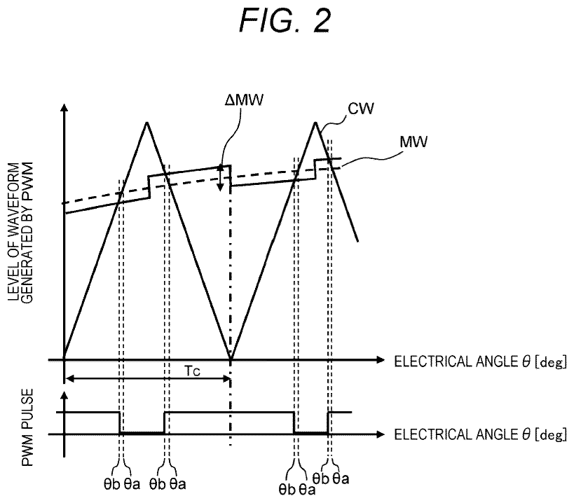

Next, details of PWM pulse control in the inverter control device 200 of the present embodiment will be described with reference to FIGS. 2, 3, 4, and 5.

FIG. 2 is a diagram illustrating an example of a method of generating a PWM pulse signal in the inverter control device 200 according to the first embodiment of the present invention. In FIG. 2, a modulation wave signal MW having an arc shape indicated by a broken line corresponds to a fundamental wave component of the three-phase voltage commands Vu*, Vv*, and Vw* to which the zero-phase voltage adjustment is not yet performed. A triangular carrier wave signal CW indicated by a solid line represents an example of an up-down count timer used for pulse width modulation, and corresponds to a carrier wave that cyclically changes at a carrier cycle Tc (carrier frequency fc).

The inverter control device 200 executes control processing of the inverter 100 at every predetermined control cycle in synchronization with the timing at which the carrier wave signal CW is reset to θ. The inverter control device 200 includes an A/D converter (not illustrated), and samples and holds various detection signals used for controlling the inverter 100, such as a detection signal of the current sensor Ict, by the A/D converter for each control cycle. Then, after elapse of an A/D conversion time of the A/D converter, a detection signal changed into a digital value is acquired, and control processing such as a current control is performed. In the sample and hold operation of the A/D converter, a voltage ripple occurs in an input voltage of the A/D converter when a detection signal is charged into a capacitor embedded in the A/D converter. The cycle of the voltage ripple (A/D conversion noise) corresponds to the control cycle (carrier cycle Tc). Therefore, the cycle of the voltage ripple superposed on an input voltage in the A/D converter can be regarded as the control cycle of the inverter control device 200, and the control cycle of the inverter control device 200 can be recognized by measuring the voltage ripple.

Note that, in the inverter control device 200, it is not always necessary to match the control cycle with the current detection cycle of the current sensor Ict, and for example, the current detection cycle can be set to an integral multiple of, such as twice, the control cycle. However, even in such a case, since the timing of detecting a current of the current sensor Ict needs to be synchronized with the control cycle of the inverter control device 200 due to the relationship of microcomputer processing in the inverter control device 200, the control cycle of the inverter control device 200 is an integral multiple of the current detection cycle. In any case, in the inverter control device 200, an integral multiple of the cycle of the voltage ripple (A/D conversion noise) occurring in the input voltage of the A/D converter can be regarded as the control cycle (the carrier cycle Tc of the PWM pulse signal).

The inverter control device 200 of the present embodiment is characterized in that controlling the functional blocks described in FIG. 1 enables performing a phase control of the PWM pulse signal synchronizing with the fundamental wave cycle of the output voltage of the inverter 100 even in a multi-pulse region in which the number of PWM pulses per electrical angle cycle is larger than 15 in an asynchronous PWM control state. This point will be described below with reference to FIG. 2.

In the inverter control device 200 of the present embodiment, for example, the PWM pulse generator 230 sets an adjustment width AMW for the modulation wave signal MW to which zero-phase voltage adjustment is not yet performed, and performs adjustment so that the difference in the level of the modulation wave signal MW between a rise section in which the carrier wave signal CW increases and a fall section in which the carrier wave signal CW decreases becomes the adjustment width AMW. Specifically, the modulation wave signal MW is adjusted so as to be a modulation wave level (MW−ΔMW/2) in the rise section of the carrier wave signal CW and be a modulation wave level (MW+ΔMW/2) in the fall section of the carrier wave signal CW. By adjusting the level of the modulation wave signal MW in this manner, each edge timing of the PWM pulse signal output from the PWM pulse generator 230 can be shifted from θa to θb. That is, the phase of the PWM pulse signal can be shifted in synchronization with the fundamental wave cycle of the output voltage (output current) of the inverter 100.

Note that, opposite to the above example, the level of the modulation MW may be adjusted so as to be a modulation wave level (MW+ΔMW/2) in the rise section of the carrier wave signal CW and be a modulation wave level (MW−ΔMW/2) in the fall section of the carrier wave signal CW. In this manner, each edge timing of the PWM pulse signal output from the PWM pulse generator 230 can be delayed. That is, the phase of the PWM pulse signal can be delayed in synchronization with the fundamental wave cycle of the output voltage (output current) of the inverter 100.

Here, increasing or decreasing the level of the modulation wave signal MW every ½ cycle of the carrier wave signal CW, that is, every ½ cycle of the PWM control, as described above corresponds to changing the zero-phase voltage Vn of the three-phase AC voltage output from the inverter 100 to the motor 300. Therefore, as described above, the PWM pulse generator 230 obtains the three-phase voltage commands Vcu*, Vcv*, and Vcw* from the zero-phase voltage adjustment using the zero-phase voltage command Vn* obtained by the zero-phase voltage command calculation unit 250, and generates from these voltage command values a PWM pulse signal for each phase to perform the phase control of the PWM pulse signal described above. Note that, in FIG. 2, the carrier cycle Tc, which is the cycle of the triangular carrier wave signal CW, represents the PWM control cycle.

In the inverter control device 200 of the present embodiment, as described above, the zero-phase voltage command calculation unit 250 calculates the zero-phase voltage command Vn*, and the PWM pulse generator 230 increases or decreases the level of the modulation wave signal MW every ½ cycle of the PWM control using the zero-phase voltage command Vn* to perform the phase control of the PWM pulse signal. As a result, for example, even in a multi-pulse region where the number of PWM pulses per electrical angle cycle is larger than 15 in a state of constant torque control in which the rotational speed of the motor 300 is relatively low, the phase control of the PWM pulse signal synchronizing with the fundamental wave cycle of the output voltage (output current) of the inverter 100 can be performed.

It is known that an output current of the inverter 100 has a large harmonic current component corresponding to the PWM pulse signal, particularly at a frequency of twice the carrier frequency fc. The harmonic current component in the output current of the inverter 100 causes a loss (harmonic loss) in the stator and the rotor of the motor 300. In the inverter control device 200 of the present embodiment, by the phase control of the PWM pulse signal as described above, the phase of the PWM pulse signal with respect to the fundamental wave of the output voltage of the inverter 100 is controlled to such a predetermined value that can reduce a harmonic loss in the motor 300. In this control, the distribution of the stator loss and the rotor loss may be adjusted to totally reduce the combined harmonic loss in the stator and the rotor. Accordingly, the temperature rise of a stator winding and the temperature rise of a rotor magnet can be reduced for an operation state of the motor 300, and thus the temperature of the motor 300 can be suppressed from reaching an operation upper limit temperature, and this enables the motor 300 to manifest an improved continuous output.

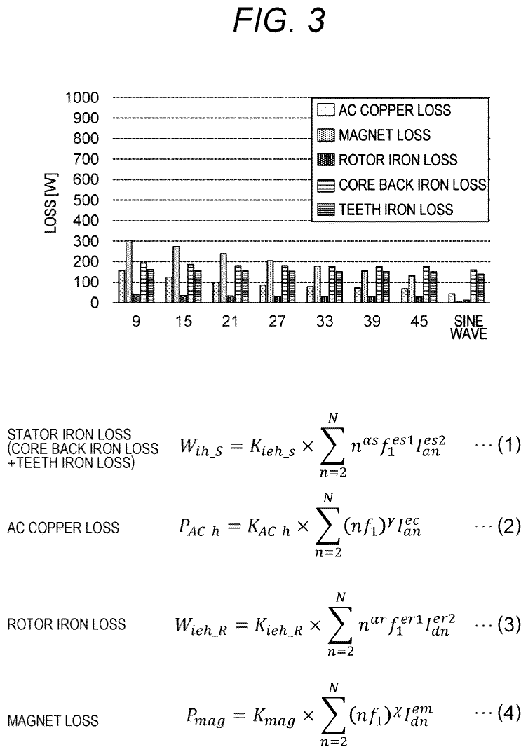

FIG. 3 is a diagram illustrating an example of a harmonic loss that occurs in the motor 300. FIG. 3 illustrates an example of magnitudes of various harmonic losses (AC copper loss, magnet loss, rotor iron loss, core back iron loss, and teeth iron loss) that occur in the motor 300 for cases where the number of PWM pulses per electrical angle cycle is 9, 15, 21, 27, 33, 39, and 45 and a case of the fundamental wave (sine wave) of the output voltage (output current) of the inverter 100.

In FIG. 3, the AC copper loss is a resistance loss that occurs when an alternating current flows in a coil installed in a stator of the motor 300. The magnet loss is a loss caused by an eddy current flowing in a permanent magnet installed in the rotor of the motor 300. The rotor iron loss is an iron loss that occurs in the rotor of the motor 300. The core back iron loss is an iron loss that occurs in a core back of the stator of the motor 300. The teeth iron loss is an iron loss that occurs in teeth of the stator of the motor 300. Among these harmonic losses, the AC copper loss, the core back iron loss, and the teeth iron loss correspond to the stator loss, and the magnet loss and the rotor iron loss correspond to the rotor loss.

The harmonic losses can be calculated by Formulas (1) to (4) expressed in FIG. 3. In Formulas (1) to (4), n represents the order of harmonic, and N represents the upper limit of the order included in calculation of harmonic loss. Further, f1 represents the fundamental wave frequency of the output voltage (output current) of the inverter 100, Ian represents an nth harmonic component of the output current, and Idn represents an nth harmonic component of a d-axis current.

In Formula (1), Wih_S represents a combined stator iron loss of the core back iron loss and the teeth iron loss, Kieh_s represents a proportional constant of the stator iron loss, as represents a fitting coefficient s, es1 represents a fitting coefficient s1, and es2 represents a fitting coefficient s2.Similarly, in Formula (2), PAC_h represents the AC copper loss, KAC_h represents a proportional constant of the AC copper loss, y represents a fitting coefficient, and ec represents a fitting coefficient c. In Formula (3), Wieh_R represents the rotor iron loss, Kieh_R represents a proportional constant of the rotor iron loss, ar represents a fitting coefficient r, er1 represents a fitting coefficient r1, and er2 represents a fitting coefficient r2. In Formula (4), Pmag represents the magnet loss, Kmag represents a proportional constant of the magnet loss, X represents a fitting coefficient, and em represents a fitting coefficient m. Various proportional constants and fitting coefficients in these formulas can be set in advance for the inverter control device 200 based on the result of a magnetic field analysis or an actual measurement performed in advance.

In the example of the harmonic loss illustrated in FIG. 3, it can be understood that as the number of PWM pulses per electrical angle cycle decreases, sensitivities of the AC copper loss and the magnet loss rises with the increase in the harmonic current and these harmonic losses increase, as compared with the sine wave component on the right end. Note that, as expressed by Formulas (2) and (4), the magnet loss can be derived from an approximation formula expressing the power of an nth order harmonic component of a d-axis current occurring by the PWM pulse signal, and the AC copper loss can be derived from an approximation formula expressing the power of an nth harmonic component of the output current occurring by the PWM pulse signal.

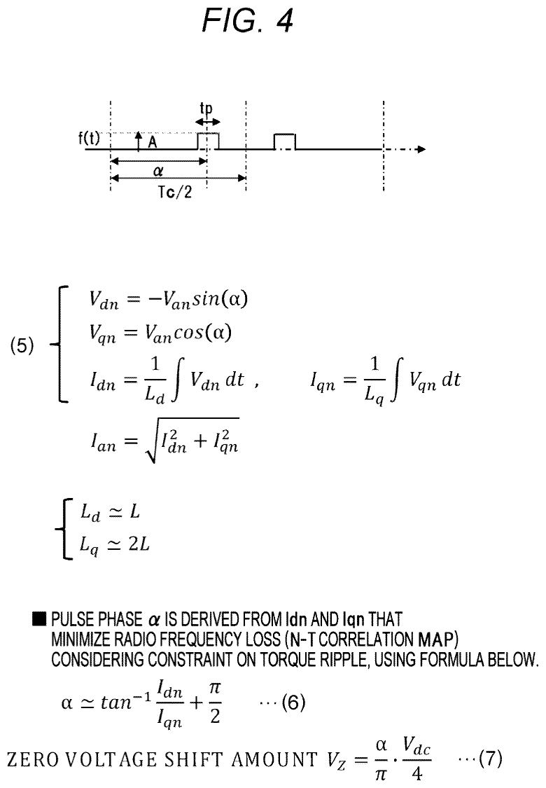

FIG. 4 is a diagram illustrating a method of calculating a PWM pulse signal. In the inverter control device 200 of the present embodiment, as described above, the PWM pulse generator 230 generates a PWM pulse signal based on the zero-phase voltage command Vn* calculated by the zero-phase voltage command calculation unit 250. Accordingly, for example, as illustrated in FIG. 4, the phase α of the PWM pulse signal can be controlled to a predetermined target phase value while keeping a pulse width tp of the PWM pulse signal constant (under a constant fundamental wave voltage). As a result, a d-axis harmonic voltage Vdn and a q-axis harmonic voltage Vqn in the output voltage of the inverter 100 corresponding to the PWM pulse signal are respectively controlled to adjust the d-axis harmonic current Idn and the q-axis harmonic current Iqn to desired values. The harmonic voltages Vdn and Vqn and the harmonic currents Idn and Iqn, and the phase α of the PWM pulse signal are expressed by Formulas (5) and (6) in FIG. 4, respectively. A shift amount Vz of the zero-phase voltage Vn corresponding to the zero-phase voltage command Vn* is expressed by Formula (7) in FIG. 4.

As described above, in the PWM pulse generator 230, by adjusting the phase α of the PWM pulse signal, the magnitude and phase of a harmonic component can be changed to adjust the d-axis harmonic current Idn and the q-axis harmonic current Iqn while maintaining a desired average output voltage of the inverter 100, thereby reducing a harmonic loss in the motor 300. Specifically, for example, in a high rotation region where there is a strict requirement for magnet temperature, the magnet loss can be minimized to suppress the rise in the magnet temperature by controlling the phase α to be around 0 or π. In addition, radio frequency losses (AC copper loss and magnet loss) corresponding to the q-axis harmonic current Iqn can also be adjusted by decreasing the d-axis harmonic current Idn. For example, in a region where reduction of a torque ripple caused by a harmonic current is desired, such as a low speed and small torque region, torque ripples can be minimized by controlling the phase α to be around ±π/2 although the magnet loss increases.

Since selection between harmonic loss and torque ripple in the motor 300 is a trade-off, it is preferable that the relationship between torque and speed is listed in advance in a table for each value of the phase α of the PWM pulse signal in the inverter control device 200. A motor that has a q-axis component inductance Lq about two times or more a d-axis component inductance Ld may be used as the motor 300. In such a case, a voltage value of about twice the d-axis harmonic voltage Vdn can be distributed to the q-axis harmonic voltage Vqn when determining the phase α.

In the present embodiment, as described above, the target harmonic current calculation unit 240 calculates the target harmonic currents (Idn*, Iqn*) based on the drive condition of the motor 300, and the PWM pulse generator 230 adjust the phase α of the PWM pulse signal by adjusting the zero-phase voltage Vn based on the zero-phase voltage command Vn* calculated by the zero-phase voltage command calculation unit 250 based on the target harmonic currents (Idn*, Iqn*). Accordingly, the d-axis harmonic voltage Vdn and the q-axis harmonic voltage Vqn in the output voltage of the inverter 100 are each controlled to forward-control the d-axis harmonic current Idn and the q-axis harmonic current Iqn to desired values. However, instead of such feedforward control, feedback control may be performed. Specifically, for example, it may be configured that the d-axis harmonic current Idn and the q-axis harmonic current Iqn are detected from the detected current values (Id, Iq) obtained by the current detector 280, and differences between these values and the target harmonic currents (Idn*, Ign*) are calculated to determine the zero-phase voltage command Vn*. By any method other than those described above, the zero-phase voltage command Vn* corresponding to the target harmonic currents (Idn*, Iqn*) can be determined to adjust the phase & of the PWM pulse signal.

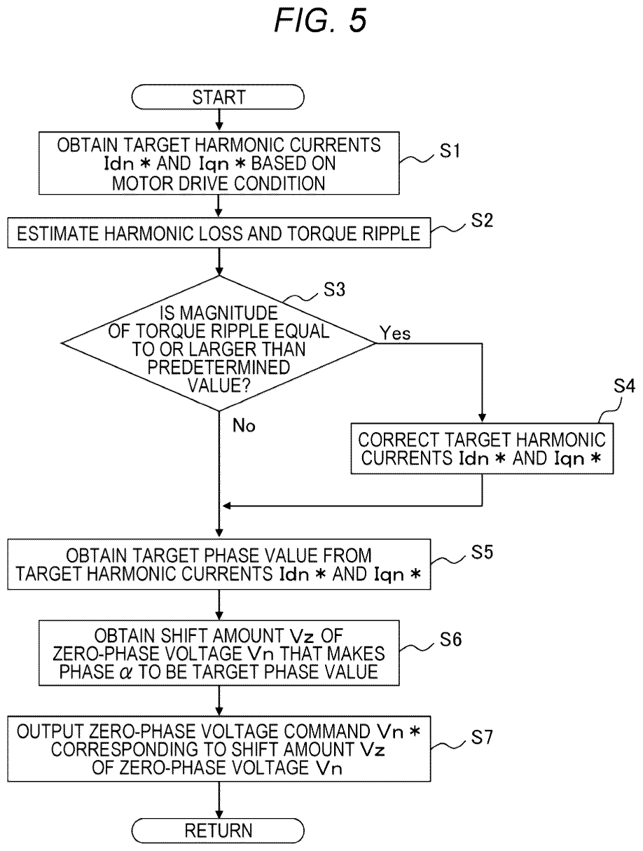

FIG. 5 is a flowchart illustrating a flow of calculation processing of the target harmonic currents (Idn*, Ign*) and the zero-phase voltage command Vn* in the inverter control device 200 according to the first embodiment of the present invention. The processing illustrated in the flowchart in FIG. 5 is executed by the target harmonic current calculation unit 240 and the zero-phase voltage command calculation unit 250 of the inverter control device 200 at, for example, a predetermined control cycle.

In step S1, the target harmonic current calculation unit 240 obtains the target harmonic currents (Idn*, Iqn*) based on the drive condition of the motor 300. For example, for each combination of the DC voltage DCV, the torque command, and the motor speed, values of the target harmonic currents (Idn*, Iqn*) that can most effectively reduce the harmonic loss for the drive condition are calculated in advance by simulation, experiment, or the like. Based on the calculation result, optimum values of the target harmonic currents (Idn*, Ign*) for each drive condition are set in a formula or a table in advance. The target harmonic currents (Idn*, Iqn*) based on the drive condition of the motor 300 can be obtained using the formula or the table.

In step S2, the target harmonic current calculation unit 240 estimates a harmonic loss and a torque ripple caused by the target harmonic currents (Idn*, Ign*) calculated in step S1. Specifically, for example, the nth harmonic component Ian in the output current of the inverter 100 and the nth harmonic component Idn in the d-axis current are calculated by Formula (5) expressed in FIG. 4. Accordingly, the torque ripple of the motor 300 is obtained, and various harmonic losses (stator iron loss, AC copper loss, rotor iron loss, and magnet loss) that occur in the motor 300 can be obtained from Formulas (1) to (4) expressed in FIG. 3. As described above, sensitivities of the AC copper loss and the magnet loss rise as the number of PWM pulses per electrical angle cycle decreases, and thus only the AC copper loss and the magnet loss may be calculated as harmonic losses.

In step S3, the target harmonic current calculation unit 240 determines whether the torque ripple magnitude estimated in step S2 is equal to or larger than a predetermined value. In this step, the torque ripple magnitude obtained in step S2 is compared with a predetermined threshold set in advance. When the torque ripple magnitude is equal to or larger than the threshold, the process proceeds to step S4, and when less than the threshold, the values of the target harmonic currents (Idn*, Iqn*) calculated in step S1 are output to the zero-phase voltage command calculation unit 250, and the process proceeds to step S5.

In step S4, the target harmonic current calculation unit 240 corrects the target harmonic currents (Idn*, Iqn*) calculated in step S1. In this step, a correction coefficient corresponding to weighting coefficients of the d-axis target harmonic current Idn* and the q-axis target harmonic current Iqn* is determined based on the motor drive condition such as the DC voltage DCV, the torque command, and the motor speed used for calculating the target harmonic currents (Idn*, Iqn*) in step S1, the harmonic loss magnitude and the torque ripple magnitude estimated in step S2, and the like, and the target harmonic currents (Idn*, Iqn*) are corrected by weighting using the correction coefficient. For example, the target harmonic currents (Idn*, Iqn*) can be corrected using a correction coefficient set in advance for each motor drive condition. Upon completion of the processing in step S4, the values of the target harmonic currents (Idn*, Ign*) corrected in step S4 are output to the zero-phase voltage command calculation unit 250, and the process proceeds to step S5.

In step S5, the zero-phase voltage command calculation unit 250 acquires the values of the target harmonic currents (Idn*, Iqn*) output from the target harmonic current calculation unit 240, and based on the values obtains a target value of the phase α of the PWM pulse signal. In this step, for example, the target value of the phase α corresponding to the target harmonic currents (Idn*, Iqn*) is calculated by Formula (6) in FIG. 4.

In step S6, the zero-phase voltage command calculation unit 250 obtains the shift amount Vz of the zero-phase voltage Vn based on the target value of the phase α obtained in step S5. For example, the shift amount Vz of the zero-phase voltage Vn corresponding to the target value of the phase α is calculated by Formula (7) in FIG. 4.

In step S7, the zero-phase voltage command calculation unit 250 outputs the zero-phase voltage command Vn * corresponding to the shift amount Vz of the zero-phase voltage Vn obtained in step S6. By the PWM pulse generator 230 adjusting the zero-phase voltage Vn according to the zero-phase voltage command Vn*, as described in FIG. 2, the modulation wave signal MW is shifted up and down at every ½ cycle of the PWM control to cause a difference in level between the rise section in which the carrier wave signal CW increases and the fall section in which the carrier wave signal CW decreases. Accordingly, the phase α of the PWM pulse signal is adjusted in accordance with the target value obtained in step S5.

In the inverter control device 200 of the present embodiment described above, the target harmonic current calculation unit 240 calculates the target harmonic currents (Idn*, Ign*) based on the drive condition of the motor 300, and the zero-phase voltage command calculation unit 250 outputs the zero-phase voltage command Vn* based on the target harmonic currents (Idn*, Iqn*). The PWM pulse generator 230 generates the PWM pulse signal based on the zero-phase voltage command Vn* output from the zero-phase voltage command calculation unit 250 to adjust the phase α of the PWM pulse signal. Accordingly, the phase α of the PWM pulse signal can be adjusted to any value not only in a synchronous PWM control state but also in an asynchronous PWM control state in which the ratio of the cycle of the three-phase voltage commands Vu*, Vv*, and Vw* used for generating the PWM pulse signal to the cycle of the carrier wave is a non-integer. Therefore, even in a multi-pulse region where the number of PWM pulses per electrical angle cycle is large, a harmonic loss can be reduced by the phase control of the PWM pulse signal. For example, harmonic losses (stator loss and rotor loss) can be reduced even for a frequency that increases a harmonic current component in an output current of the inverter 100 (a frequency twice the carrier frequency fc) in a constant torque control region in which the rotational speed of the motor 300 is relatively low.

In addition, in the inverter control device 200 of the present embodiment described above, by adjusting the phase α of the PWM pulse signal based on the zero-phase voltage command Vn*, distribution of stator loss and rotor loss in the harmonic loss can be adjusted and distribution of harmonic loss and torque ripple can also be adjusted. As a result, for example, a torque ripple can be adjusted while reducing the temperature rise of the stator winding and the rotor magnet based on the drive condition of the motor 300, and thus, a continuous motor output and reduction in noise and vibration can both be obtained.

In the inverter control device 200 of the present embodiment, when the target harmonic currents (Idn*, Iqn*) are corrected by weighting so as to decrease the d-axis harmonic current Idn and increase the q-axis harmonic current Iqn to minimize the harmonic loss of the motor 300, a torque ripple caused by the harmonic current in the motor 300 may increase. In such a case, to reduce the harmonic current flowing in the motor 300 to suppress the harmonic loss, the frequency of the carrier wave used for generating the PWM pulse signal in the PWM pulse generator 230 may be switched to a frequency higher than that in a normal state. Specifically, for example, in the PWM pulse generator 230, the frequency of the carrier wave is set switchable between two frequency types, that is, a high-frequency side and a low-frequency side. Provided that the frequency of the carrier wave is in the low-frequency side in a normal state, when the output torque of the motor 300 corresponding to the torque command input from the master controller is within a predetermined first range and the magnitude of the harmonic loss (stator loss and rotor loss) estimated by the zero-phase voltage command calculation unit 250 is within a predetermined second range, the frequency of the carrier wave is switched from the low-frequency side to the high-frequency side. With this configuration, the harmonic loss of the motor 300 can be reduced while the torque ripple occurring in the motor 300 is suppressed. In particular, in the inverter 100, when a highly responsive semiconductor element such as SiC and GaN is used for the semiconductor switching element of the three-phase inverter circuit, a high effect can be obtained.

According to the first embodiment of the present invention described above, the following effects are obtained.
(1) The inverter control device 200 is a device that controls the inverter 100 that drives a three-phase inverter circuit to convert a direct current into a three-phase alternating current and outputs the three-phase alternating current to the motor 300. The inverter control device 200 includes the PWM pulse generator 230 that performs pulse width modulation on the three-phase voltage commands Vu*, Vv*, and Vw* using a cyclically changing carrier wave to generates a PWM pulse signal for controlling the driving of the three-phase inverter circuit, and the target harmonic current calculation unit 240 that calculates, based on a drive condition of the motor 300, target harmonic currents (Idn*, Iqn*) for reducing a stator loss and a rotor loss respectively occurring in the stator and the rotor of the motor 300 due to a harmonic current flowing in the motor 300, the harmonic current corresponding to the PWM pulse signal. The PWM pulse generator 230 generates a PWM pulse signal that makes, based on the target harmonic currents (Idn*, Iqn*), the zero-phase voltage Vn, which is the sum of the three-phase output voltages Vu, Vv, and Vw from the three-phase inverter circuit, non-zero. Accordingly, the phase α of the PWM pulse signal can be controlled to a predetermined target phase value, and the magnitudes of the d-axis harmonic current Idn and the q-axis harmonic current Ign in the motor 300 can be adjusted. As a result, a radio frequency loss of the motor 300 can be effectively reduced regardless of the number of PWM pulses per electrical angle cycle.
(2) The inverter control device 200 includes the zero-phase voltage command calculation unit 250 that calculates the zero-phase voltage command Vn* for changing the zero-phase voltage Vn every ½ cycle of the carrier wave based on the target harmonic currents (Idn*, Iqn*). The PWM pulse generator 230 generates a PWM pulse signal based on the zero-phase voltage command Vn*. With this configuration, the PWM pulse signal of which phase α is controlled to a predetermined target phase value so as the zero-phase voltage Vn to be changed to non-zero can be generated.
(3) The PWM pulse generator 230 generates the PWM pulse signal so as the zero-phase voltage Vn to change in synchronization with the three-phase voltage commands Vu*, Vv*, and Vw* in an asynchronous PWM control state in which the ratio of the cycle of the three-phase voltage commands Vu*, Vv*, and Vw* to the cycle of the carrier wave is a non-integer. With this configuration, even in an asynchronous PWM control state, the phase α of the PWM pulse signal can be adjusted to a predetermined target phase value to reduce a radio frequency loss of the motor 300.
(4) The target harmonic current calculation unit 240 corrects the calculated target harmonic currents (Idn*, Iqn*) (step S4). In this step, the PWM pulse generator 230 generates the PWM pulse signal based on the corrected target harmonic currents (Idn*, Iqn*). With this configuration, for example, when a torque ripple of the motor 300 has a magnitude of a predetermined value or larger, a radio frequency loss of the motor 300 can be adjusted to suppress the torque ripple.
(5) The PWM pulse generator 230 may switch the frequency of the carrier wave to a frequency higher than that in a normal state when the output torque of the motor 300 is within a predetermined first range and the magnitude of a combined harmonic loss of the stator and the rotor is within a predetermined second range. With this configuration, the harmonic loss of the motor 300 can be reduced while the torque ripple occurring in the motor 300 is suppressed.

### Second Embodiment

Next, a second embodiment of the present invention will be described. In the present embodiment, an example will be described in which a target phase value for the phase α of the PWM pulse signal is set without using the zero-phase voltage command Vn* described above, and a PWM pulse signal is generated based on the target phase value.

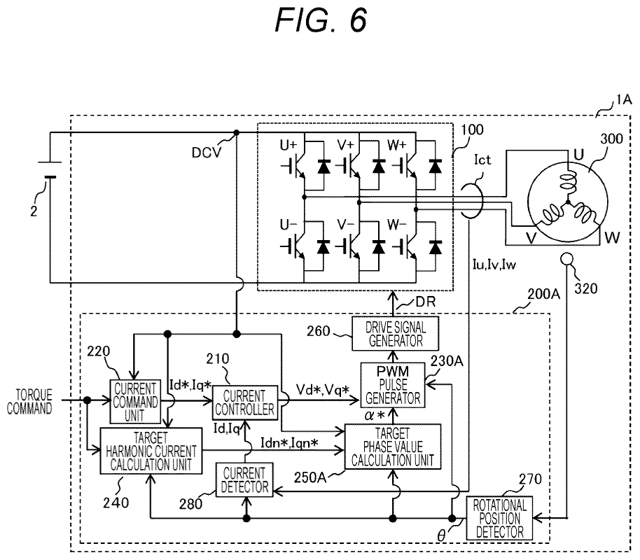

FIG. 6 is a block diagram illustrating a configuration of a motor drive system 1A including an inverter control device 200A according to the second embodiment of the present invention. The motor drive system 1A of the present embodiment is different from the motor drive system 1 in FIG. 1 described in the first embodiment in that the configuration of the inverter control device 200A is partially different. Other points are common to the motor drive system 1 and description thereof is omitted unless it is necessary.

The inverter control device 200A includes functional blocks that are a current controller 210, a current command unit 220, a PWM pulse generator 230A, a target harmonic current calculation unit 240, a target phase value calculation unit 250A, a drive signal generator 260, a rotational position detector 270, and a current detector 280. Note that the functional blocks other than the PWM pulse generator 230A and the target phase value calculation unit 250A are respectively the same as those of the inverter control device 200 of the first embodiment, and thus, description thereof will be omitted.

The target phase value calculation unit 250A calculates a target phase value of the phase & of the PWM pulse signal generated by the PWM pulse generator 230 based on target harmonic currents (Idn*, Iqn*) calculated by the target harmonic current calculation unit 240 and the DC voltage DCV of the battery 2, and outputs a phase command value α* corresponding to the target phase value. The phase command value α* corresponds to the target value of the phase α used for calculating the zero-phase voltage command Vn* in the first embodiment, and is calculated by Formula (6) expressed in FIG. 4.

The PWM pulse generator 230A performs three-phase pulse width modulation (PWM) based on voltage commands (Vd*, Vq*) obtained by the current controller 210, the phase command value α* output from the target phase value calculation unit 250A, and a rotational position θ to generate a PWM pulse signal for controlling the inverter 100. Specifically, for example, the PWM pulse generator 230A calculates three-phase voltage commands Vu*, Vv*, and Vw* (U-phase voltage command value Vu*, V-phase voltage command value Vv*, and W-phase voltage command value Vw*) by performing two-phase/three-phase conversion on the voltage commands (Vd*, Vq*) using the rotational position θ. Then, based on the obtained three-phase voltage commands Vu*, Vv*, and Vw* and the phase command value α*, a compare match timer for a carrier wave is set for each phase, and comparison with the carrier wave that cyclically changes at a carrier frequency fc is performed for each phase. Accordingly, the position (phase) of a pulse edge in each phase can be determined to generate a PWM pulse signal for each phase.

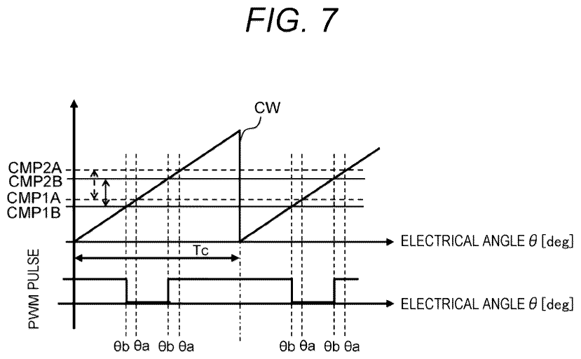

FIG. 7 is a diagram illustrating an example of a method of generating a PWM pulse signal in the inverter control device 200A according to the second embodiment of the present invention. In the present embodiment, as illustrated in FIG. 7, a carrier wave signal CW is not a triangular wave but is generated as a sawtooth wave by an up-and-down count timer.

In the inverter control device 200A of the present embodiment, the PWM pulse generator 230A offsets, based on the phase command value α*, compare match register values that are set according to the three-phase voltage commands Vu*, Vv*, and Vw*. Specifically, as illustrated in FIG. 7 for example, compare match register values CMP1A and CMP2A that are set to correspond to the three-phase voltage commands Vu*, Vv*, and Vw* are offset to smaller values by an amount corresponding to the phase command value α*, whereby compare match register values CMP1B and CMP2B are set. By offsetting the compare match register values in this manner, each edge timing of the PWM pulse signal output from the PWM pulse generator 230A can be shifted from θa to θb as in the first embodiment. That is, the phase of the PWM pulse signal can be shifted in synchronization with the fundamental wave cycle of the output voltage (output current) of the inverter 100.

Opposite to the example described above, the compare match register value may be offset to a value larger by an amount corresponding to the phase command value α*. In this manner, each edge timing of the PWM pulse signal output from the PWM pulse generator 230A can be delayed. That is, the phase of the PWM pulse signal can be delayed in synchronization with the fundamental wave cycle of the output voltage (output current) of the inverter 100.

In the inverter control device 200a of the present embodiment, as described above, the target phase value calculation unit 250A calculates the target phase value of the phase α of the PWM pulse signal, and the PWM pulse generator 230A offsets the compare match register values using the phase command value α* corresponding to the target phase value, whereby a phase control of the PWM pulse signal is performed. With this configuration, as in the first embodiment, for example, even in a multi-pulse region where the number of PWM pulses per electrical angle cycle is larger than 15 in a state of constant torque control in which the rotational speed of the motor 300 is relatively low, the phase control of the PWM pulse signal synchronizing with the fundamental wave cycle of the output voltage (output current) of the inverter 100 can be performed. Furthermore, in the present embodiment, the phase of the PWM pulse signal can be controlled only by offsetting the compare match register value, so that there is also an advantage of reducing a processing load of a microcomputer used as the inverter control device 200A.

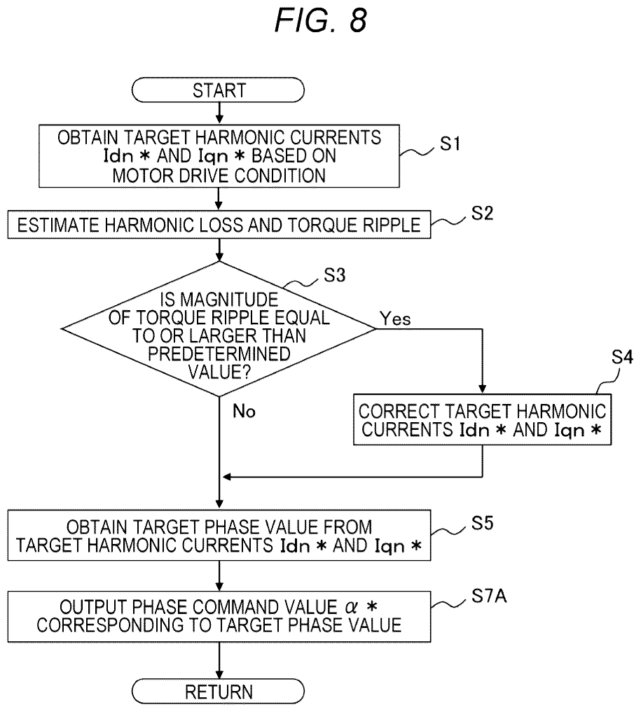

FIG. 8 is a flowchart illustrating a flow of calculation processing of the target harmonic currents (Idn*, Ign*) and the target phase value in the inverter control device 200A according to the second embodiment of the present invention. The processing illustrated in the flowchart in FIG. 8 is executed by the target harmonic current calculation unit 240 and the target phase value calculation unit 250A of the inverter control device 200A at a predetermined control cycle, for example.

In steps S1 to S5, processing similar to steps S1 to S5 in FIG. 5 described in the first embodiment is executed. In the present embodiment, the processing in step S5 is executed by the target phase value calculation unit 250A.

In step S7A, the target phase value calculation unit 250A outputs the phase command value α* corresponding to the target value of the phase α obtained in step S5. The PWM pulse generator 230A offsets the compare match register value according to the phase command value α*, so that the phase α of the PWM pulse signal is adjusted according to the target value obtained in step S5 as described with reference to FIG. 7.

According to the second embodiment of the present invention described above, the inverter control device 200A includes the target phase value calculation unit 250A that calculates the target phase value for the phase α of the PWM pulse signal based on the target harmonic currents (Idn*, Iqn*). The PWM pulse generator 230A generates a PWM pulse signal based on the target phase value. With this configuration, as in the first embodiment, the PWM pulse signal of which phase α is controlled to a predetermined target phase value can be generated.

### Third Embodiment

Next, a third embodiment of the present invention will be described. In the present embodiment, an example in which the motor drive systems described in the first and second embodiments are mounted on an electric vehicle will be described.

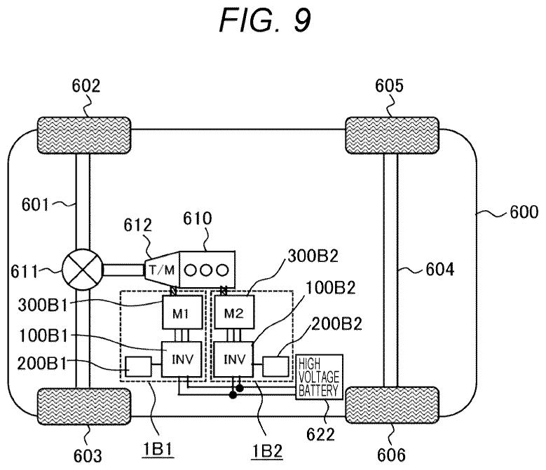

FIG. 9 is a view illustrating a configuration of an electric vehicle 600 according to the third embodiment of the present invention. An electric vehicle 600 has a power train to which a motor drive system 1B1 for traveling (a motor 300B1, an inverter 100B1, and an inverter control device 200B1) and a motor drive system 1B2 for power generation (a motor 300B2, an inverter 100B2, and an inverter control device 200B2) are applied. The inverter control devices 200B1 and 200B2 each have a configuration similar to that of the inverter control device 200 described in the first embodiment or the inverter control device 200A described in the second embodiment. The motors 300B1 and 300B2 each have a configuration similar to that of the motor 300, and the inverters 100B1 and 100B2 each have a configuration similar to that of the inverter 100.

A front wheel axle 601 is rotatably supported on a front portion of the electric vehicle 600, and front wheels 602 and 603 are provided at two ends of the front wheel axle 601. A rear wheel axle 604 is rotatably supported on a rear portion of the electric vehicle 600, and rear wheels 605 and 606 are provided at two ends of the rear wheel axle 604.

A differential gear 611 which is a power distribution mechanism is provided in a central portion of the front wheel axle 601, and an engine 610 or the motor 300B1 distributes a rotational driving force transmitted via a transmission 612 to the left and right front wheel axles 601. The engine 610 and the motors 300B1 and 300B2 each have a mechanism that can be mechanically coupled/decoupled using a mechanism mounted on the transmission 612. Therefore, it can be selectively switched between a series hybrid mode and a parallel hybrid mode, where in the series hybrid mode, the engine 610 and the motor 300B2 are mechanically coupled and only a mechanical output of the motor 300B1 is transmitted to the differential gear 611 to cause the vehicle to travel, and in the parallel hybrid mode, the mechanical outputs of the engine 610 and the motor 300B1 are transmitted together to the differential gear 611 to cause the vehicle to travel. By arbitrarily switching between the series hybrid mode and the parallel hybrid mode according to a traveling scene such as urban traveling and expressway traveling, the electric vehicle 600 can perform both vehicle maneuverability and vehicle cruising distance.

The inverter 100B1 converts DC power supplied from a high-voltage battery 622 into three-phase AC power according to the control by the inverter control device 200B1. The three-phase AC power output from the inverter 100B1 is supplied to a stator coil of a stator included in the motor 300B1. Accordingly, a rotor of the motor 300B1 rotates and generates a rotational driving force corresponding to the three-phase AC power (current). The rotor included in the motor 300B2 is rotationally driven by a mechanical output from the engine 610. This generates three-phase AC power in a stator coil of the motor 300B2, and the three-phase AC power is input to the inverter 100B2. The inverter 100B2 converts the three-phase AC power input from the motor 300B2 into DC power according to the control by the inverter control device 200B2 to charge the high-voltage battery 622.

Reduction of losses in the motors 300B1 and 300B2 when the electric vehicle 600 is travelling is desired for a longer travel distance. In the present embodiment, as described in the first and second embodiments, the inverter control devices 200B1 and 200B2 each calculate the target harmonic currents (Idn*, Ign*) and adjust the phase α of a PWM pulse signal based on the calculated target harmonic currents to reduce a harmonic loss of the motors 300B1 and 300B2.

For example, the inverter control device 200B1 of the motor drive system 1B1 inputs a torque command corresponding to an operated amount of an accelerator pedal of the electric vehicle 600, performs current feedback control so as to obtain a three-phase AC power (current) corresponding to the torque command, and calculates a voltage command value for the inverter 100B1. Further, pulse width modulation is performed by comparing the voltage command value with the carrier wave, and a PWM pulse signal for driving the inverter 100B1 is generated. In this step, the target harmonic current calculation unit 240 of the inverter control device 200B1 calculates the target harmonic currents (Idn*, Iqn*) based on a drive condition of the motor 300B1 using the torque command, a motor speed that is the temporal change of the rotational position θ, and a DC voltage DCV of the high-voltage battery 622. The zero-phase voltage command calculation unit 250 or the target phase value calculation unit 250A obtains a target phase value of the phase a of the PWM pulse signal based on the target harmonic currents (Idn*, Iqn*) calculated by the target harmonic current calculation unit 240, and calculates a zero-phase voltage command Vn* or a phase command value α*. The PWM pulse generator 230 generates a PWM pulse signal so as the phase α to become the target phase value based on the zero-phase voltage command Vn* from the zero-phase voltage command calculation unit 250 or the phase command value α* from the target phase value calculation unit 250A. Accordingly, a PWM pulse signal that makes the zero-phase voltage, which is the sum of three-phase output voltages Vu, Vv, and Vw output from the inverter 100B1 to the motor 300B1, non-zero is generated. Then, by driving the three-phase inverter circuit included in the inverter 100B1 by a drive signal DR generated by the drive signal generator 260 based on the PWM pulse signal, radio frequency losses (stator loss and rotor loss) of the motor 300B1 are reduced.

In the motor drive system 1B2 for power generation, similarly to the motor drive system 1B1 for traveling, the radio frequency loss of the motor 300B2 can be reduced.

As described above, in the electric vehicle 600, by adjusting the phase of the PWM pulse signal in the motor drive systems 1B1 and 1B2, a component of a specific order among harmonic components in the three-phase AC power output from the inverters 100B1 and 100B2 to the motors 300B1 and 300B2 can be cancelled. Accordingly, the harmonic loss in the motors 300B1 and 300B2 can be reduced, and as a result, a restriction on output due to the rise in temperature of the motors 300B1 and 300B2 on an ascending climbing road, for example, can be moderated.

In the present embodiment, the case where the electric vehicle 600 is a hybrid car has been described, but the present invention is also applicable to a plug-in hybrid car, an electric car, and the like, and a similar effect can be obtained also in such cases.

In each of the embodiments described above, an example in which the inverter control device is separated from the inverter and the motor has been described. However, as long as the functions described above are equipped, the present invention can also be applied to an inverter device in which an inverter control device and an inverter are integrated, or a motor drive system in which an inverter device and a motor are integrated. In each of the embodiments described above, an application example in a multi-pulse region in an asynchronous PWM control state has been described. However, the present invention is also applicable to a synchronous PWM control state in which the ratio of the cycle of the three-phase voltage commands Vu*, Vv*, and Vw* used for generating the PWM pulse signal to the cycle of the carrier wave is an integer. It will be applicable to the entire rotational speed range of the motor by applying the present invention in both the asynchronous PWM control state and the synchronous PWM control state.

Note that the present invention is not limited to the embodiments described above, and various modifications can be made without departing from the gist of the present invention.

### REFERENCE SIGNS LIST

1, 1A, 1B1, 1B2 motor drive system
2 battery
100, 100B1, 100B2 inverter
200, 200A, 200B1, 200B2 inverter control device
210 current controller
220 current command unit
230, 230A PWM pulse generator
240 target harmonic current calculation unit
250 zero-phase voltage command calculation unit
250A target phase value calculation unit
260 drive signal generator
270 rotational position detector
280 current detector
300, 300B1, 300B2 motor
320 rotational position sensor
600 electric vehicle

1. An inverter control device for controlling an inverter that converts a direct current into a three-phase alternating current by driving a three-phase inverter circuit and outputs the three-phase alternating current to a motor, the device comprising:
a PWM pulse generator that performs pulse width modulation on a three-phase voltage command using a carrier wave that cyclically changes, and generates a PWM pulse signal for controlling driving of the three-phase inverter circuit; and
a target harmonic current calculation unit that calculates, based on a drive condition of the motor, a target harmonic current for reducing a stator loss and a rotor loss that respectively occur in a stator and a rotor of the motor due to a harmonic current flowing in the motor in response to the PWM pulse signal, wherein
the PWM pulse generator generates the PWM pulse signal that makes a zero-phase voltage to be non-zero based on the target harmonic current, the zero-phase voltage being a sum of three-phase output voltages from the three-phase inverter circuit.

2. The inverter control device according to claim 1, further comprising
a zero-phase voltage command calculation unit that calculates a zero-phase voltage command for changing the zero-phase voltage every ½ cycle of the carrier wave based on the target harmonic current, wherein
the PWM pulse generator generates the PWM pulse signal based on the zero-phase voltage command.

3. The inverter control device according to claim 1, further comprising
a target phase value calculation unit that calculates a target phase value of a phase of the PWM pulse signal based on the target harmonic current, wherein
the PWM pulse generator generates the PWM pulse signal based on the target phase value.

4. The inverter control device according to claim 1, wherein
the PWM pulse generator generates the PWM pulse signal that causes the zero-phase voltage to change in synchronization with the three-phase voltage command in an asynchronous PWM control state, a ratio of a cycle of the three-phase voltage commands to a cycle of the carrier wave being non-integer in the asynchronous PWM control state.

5. The inverter control device according to claim 1, wherein
the target harmonic current calculation unit corrects the target harmonic current that has been calculated, and
the PWM pulse generator generates the PWM pulse signal based on the target harmonic current that has been corrected.

6. The inverter control device according to claim 1, wherein
the PWM pulse generator switches a frequency of the carrier wave to a frequency higher than a frequency in a normal state when an output torque of the motor is within a predetermined first range and a magnitude of a harmonic loss is within a predetermined second range, the harmonic loss being a combination of the stator loss and the rotor loss.

7. An electric vehicle comprising:
a motor including a stator and a rotor;
a battery that supplies a direct current;
an inverter that includes a three-phase inverter circuit, coverts the direct current into a three-phase alternating current by driving the three-phase inverter circuit, and outputs the three-phase alternating current to the motor; and
an inverter control device that controls the inverter, wherein
the inverter control device includes
a PWM pulse generator that performs pulse width modulation on a three-phase voltage command using a carrier wave that cyclically changes, and generates a PWM pulse signal for controlling driving of the three-phase inverter circuit, and
a target harmonic current calculation unit that calculates, based on a drive condition of the motor, a target harmonic current for reducing a stator loss and a rotor loss that respectively occur in the stator and the rotor due to a harmonic current flowing in the motor in response to the PWM pulse signal, and
the PWM pulse generator generates the PWM pulse signal that makes a zero-phase voltage to be non-zero based on the target harmonic current, the zero-phase voltage being a sum of three-phase output voltages from the three-phase inverter circuit.
